(19) United States
(12) Patent Application Publication
(10) Pub. No.: US 2026/0105492 A1
(43) Pub. Date: Apr. 16, 2026

(54) PERSONALIZED ADVERTISING GENERATION USING USER PROFILE DATA

(71) Applicant: Meta Platforms Technologies, LLC, Menlo Park, CA (US)

(72) Inventor: Prateek Yadav, Fairfax, VA (US)

(73) Assignee: Meta Platforms Technologies, LLC, Menlo Park, CA (US)

(21) Appl. No.: 19/357,420

(22) Filed: Oct. 14, 2025

Related U.S. Application Data
(60) Provisional application No. 63/707,806, filed on Oct. 16, 2024.

(51) Int. Cl. G06Q 30/0251

(52) U.S. Cl. CPC G06Q 30/0271

(57) ABSTRACT

Embodiments include systems, methods, and computer-readable media for personalized advertising generation using user profile data. An example method may include receiving an advertisement package, the advertisement package comprising an image, a designation of a replaceable portion of the image, and a set of characteristics of a replacement image usable instead of the replaceable portion of the image in a generated advertisement, selecting, using the set of characteristics, a replacement image from a user profile of a user, and replacing, using a generative machine learning model, in a generated advertisement corresponding to the advertisement package, the replaceable portion of the image with the replacement image.

### CROSS-REFERENCE TO RELATED APPLICATION

This application claims the benefit of US Application No. 63/707,806, filed October 16, 2024, the entirety of which is hereby incorporated by reference.

### TECHNICAL FIELD

The present disclosure generally relates to online advertising technology, and more particularly to personalized advertising generation using user profile data.

### BACKGROUND

An advertisement, as used herein, refers to paid content displayed to an online user (e.g., a user using a website or software application such as a social media application). An advertiser typically supplies all of the content to be used in the advertisement (e.g., an image or video, and optional audio), as well as characteristics of a desired audience of the advertisement (e.g., users between the ages of 18 and 21 who have previously expressed interest in a singer, located in a specified list of cities, for an advertisement of the singer’s upcoming tour to those cities, or users between the ages of 35 and 55, who have previously expressed interest in skiing and an estimated annual income above a specified number, for an advertisement of an upscale ski resort).

Some advertisers use elements in their advertisements to which different users react differently. For example, a user who dislikes football might be negatively influenced by a car advertisement featuring a football player, or a user who likes cats better than dogs might react more favorably to a beer advertisement featuring cats than one featuring dogs.

Thus, to improve both advertiser return on investment and users’ experience, there is a need to improve advertising by adding personalization.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement personalized advertising generation using user profile data, according to some embodiments.

FIG. 2 is a block diagram illustrating details of a system for personalized advertising generation using user profile data, according to some embodiments.

FIG. 3 depicts a block diagram of an example configuration for personalized advertising generation using user profile data, in accordance with an illustrative embodiment.

FIG. 4 depicts a flowchart of an example process for personalized advertising generation using user profile data, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing personalized advertising generation using user profile data. In particular, an embodiment receives an advertisement package, the advertisement package comprising an image, a designation of a replaceable portion of the image, and a set of characteristics of a replacement image usable instead of the replaceable portion of the image in a generated advertisement; selects, using the set of characteristics, a replacement image from a user profile of a user; and replaces, using a generative machine learning model, in a generated advertisement corresponding to the advertisement package, the replaceable portion of the image with the replacement image.

An embodiment receives an advertisement package. An advertisement package includes an image, a designation of a replaceable portion of the image, and a set of characteristics of a replacement image usable instead of the replaceable portion of the image in a generated advertisement. For example, an advertisement package might include an image of a person gesturing towards a car, a designation of the person as the replaceable portion of the image, and a set of characteristics indicating that if a user has consented, an image of the user can be used as the replacement image. In some embodiments, an advertisement package also includes audio data, a designation of a replaceable portion of the audio data, and a set of characteristics of a replacement audio portion usable instead of the replaceable portion of the audio data in a generated advertisement. In some embodiments, the set of characteristics of the replacement audio portion includes a specification of text intended to be converted into audio in the generated advertisement. For example, the specification of text might be to insert the user’s name in a designated location, or the city the user lives in. In some embodiments, the image and replacement image are video instead of a single image.

Using the set of characteristics, an embodiment selects a replacement image from a user’s user profile. For example, the set of characteristics in one advertisement package might specify that the replacement image be of the user, while the set of characteristics in another advertisement package might specify that the replacement image be an image of a direct connection of the user, or an image the user has previously indicated an affinity for (e.g., a singer whose previous posts the user has liked on a social media platform). Note that all use of images as replacement images is on an opt-in basis.

One embodiment asks a user to identify one or more candidate replacement images, from images already in the user’s profile or otherwise available for use in advertisements. Another embodiment uses a presently available technique, such as an image classification model, to identify one or more candidate replacement images, from images already in the user’s profile or otherwise available for use in advertisements, based on one or more selection criteria. For example, an embodiment might identify candidate replacement images of the user, the user’s five closest friends, and other people the user has liked the most in the last month.

Using the set of characteristics, if audio of the advertisement is to be replaced, an embodiment selects replacement audio data from a user’s user profile. Techniques are presently available to extract the user’s voice from recordings the user has saved, sent to social media contacts, or are present in a user profile for another reason.

Using a generative machine learning model, in a generated advertisement corresponding to the advertisement package, an embodiment replaces the replaceable portion of the image with the replacement image. For example, if an advertisement package includes an image of a person gesturing towards a car, a designation of the person as the replaceable portion of the image, and a set of characteristics indicating that if a user has consented, an image of the user can be used as the replacement image, an embodiment might generate an advertisement including an image of the user gesturing towards the car. Using another generative machine learning model, in a generated advertisement corresponding to the advertisement package, an embodiment replaces the replaceable portion of the audio data with the replacement audio data, for example replacing a stock voice in the advertisement with the user’s voice or inserting the user’s name or location in a designated portion of the advertisement. Generative machine learning models that generate still images, video, and audio are presently available. For example, a Generative Adversarial Network (GAN) is one presently available technique for image and video generation.

An embodiment displays the generated advertisement to the user whose user profile was used to select a replacement image or audio. Another embodiment causes the generated advertisement to be displayed to the user via an advertising insertion service, in an application, or on a website.

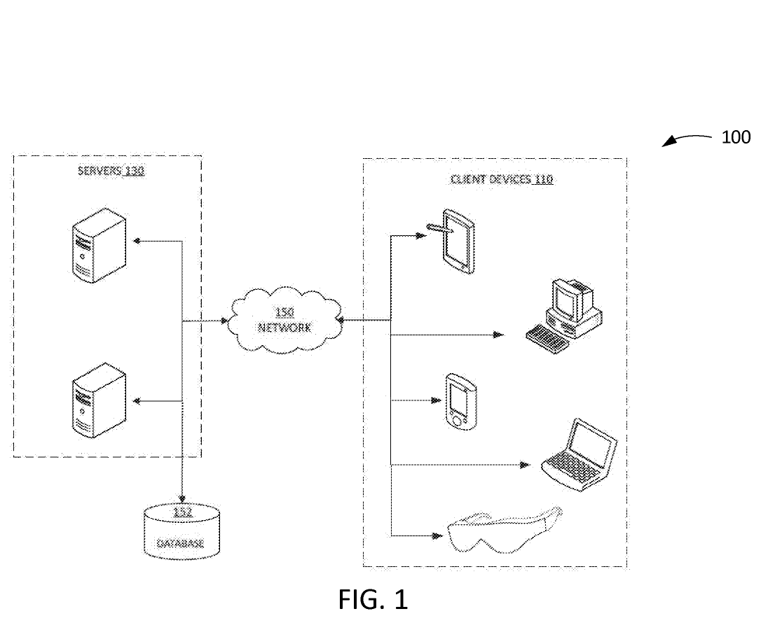

FIG. 1 illustrates a network architecture 100 used to implement personalized advertising generation using user profile data, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

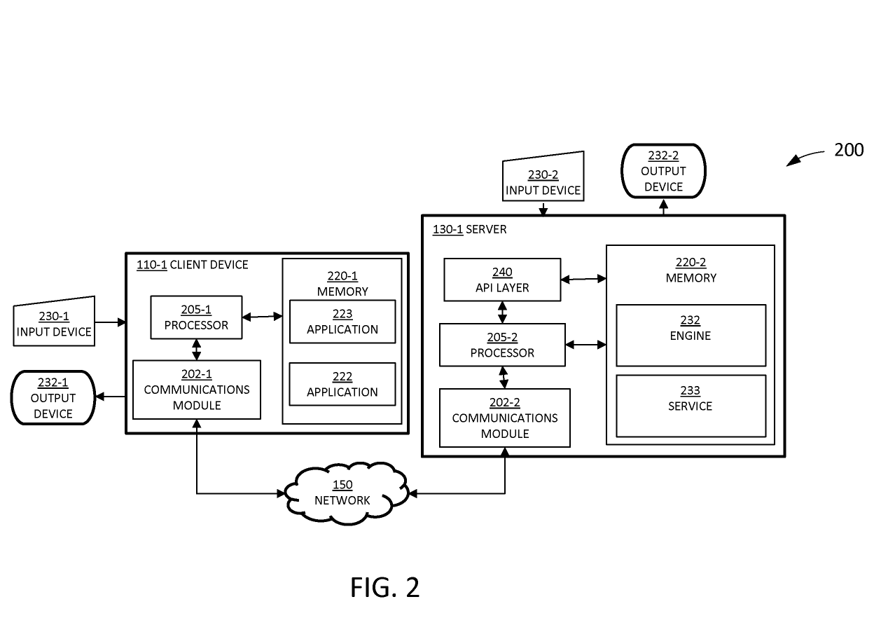

FIG. 2 is a block diagram illustrating details of a system 200 for personalized advertising generation using user profile data, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement personalized advertising generation using user profile data. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide personalized advertising generation using user profile data. The application 223 may communicate with service 233 through API layer 240, for example.

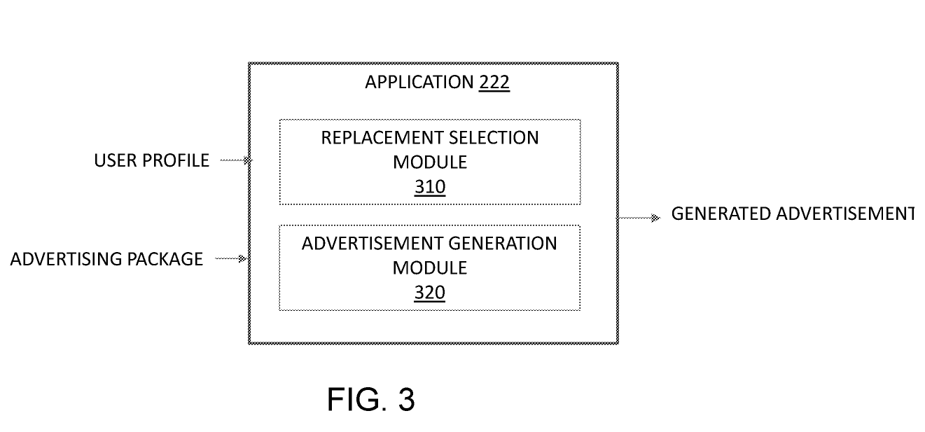

FIG. 3 depicts personalized advertising generation using user profile data, in accordance with an illustrative embodiment. Application 222 is the same as application 222 in FIG. 2.

Application 222 receives an advertisement package. An advertisement package includes an image, a designation of a replaceable portion of the image, and a set of characteristics of a replacement image usable instead of the replaceable portion of the image in a generated advertisement. For example, an advertisement package might include an image of a person gesturing towards a car, a designation of the person as the replaceable portion of the image, and a set of characteristics indicating that if a user has consented, an image of the user can be used as the replacement image. In some implementations of application 222, an advertisement package also includes audio data, a designation of a replaceable portion of the audio data, and a set of characteristics of a replacement audio portion usable instead of the replaceable portion of the audio data in a generated advertisement. In some implementations of application 222, the set of characteristics of the replacement audio portion includes a specification of text intended to be converted into audio in the generated advertisement. For example, the specification of text might be to insert the user’s name in a designated location, or the city the user lives in. In some implementations of application 222, the image and replacement image are video instead of a single image.

Using the set of characteristics, replacement selection module 310 selects a replacement image from a user’s user profile. For example, the set of characteristics in one advertisement package might specify that the replacement image be of the user, while the set of characteristics in another advertisement package might specify that the replacement image be an image of a direct connection of the user, or an image the user has previously indicated an affinity for (e.g., a singer whose previous posts the user has liked on a social media platform). Note that all use of images as replacement images is on an opt-in basis.

One implementation of module 310 asks a user to identify one or more candidate replacement images, from images already in the user’s profile or otherwise available for use in advertisements. Another implementation of module 310 uses a presently available technique, such as an image classification model, to identify one or more candidate replacement images, from images already in the user’s profile or otherwise available for use in advertisements, based on one or more selection criteria. For example, module 310 might identify candidate replacement images of the user, the user’s five closest friends, and other people the user has liked the most in the last month.

Using the set of characteristics, if audio of the advertisement is to be replaced, module 310 selects replacement audio data from a user’s user profile. Techniques are presently available to extract the user’s voice from recordings the user has saved, sent to social media contacts, or are present in a user profile for another reason.

Using a generative machine learning model, in a generated advertisement corresponding to the advertisement package, advertisement generation module 320 replaces the replaceable portion of the image with the replacement image. For example, if an advertisement package includes an image of a person gesturing towards a car, a designation of the person as the replaceable portion of the image, and a set of characteristics indicating that if a user has consented, an image of the user can be used as the replacement image, module 320 might generate an advertisement including an image of the user gesturing towards the car. Using another generative machine learning model, in a generated advertisement corresponding to the advertisement package, module 320 replaces the replaceable portion of the audio data with the replacement audio data, for example replacing a stock voice in the advertisement with the user’s voice or inserting the user’s name or location in a designated portion of the advertisement. Generative machine learning models that generate still images, video, and audio are presently available. For example, a Generative Adversarial Network (GAN) is one presently available technique for image and video generation.

Application 222 displays the generated advertisement to the user whose user profile was used to select a replacement image or audio. Another implementation of application 222 causes the generated advertisement to be displayed to the user via an advertising insertion service, in an application, or on a website.

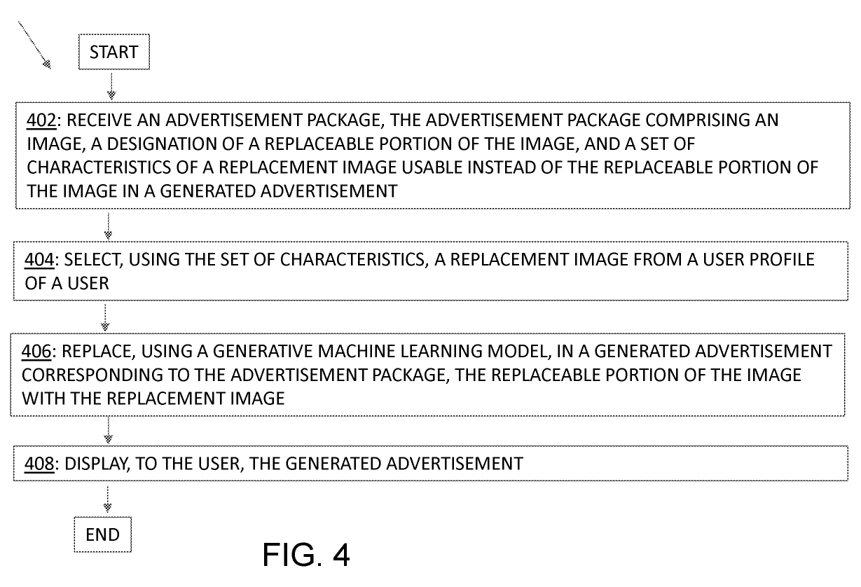

FIG. 4 depicts a flowchart of an example process for personalized advertising generation using user profile data, in accordance with an illustrative embodiment. Process 400 can be implemented in application 222 in FIG. 2.

At block 402, the process receives an advertisement package, the advertisement package comprising an image, a designation of a replaceable portion of the image, and a set of characteristics of a replacement image usable instead of the replaceable portion of the image in a generated advertisement. At block 404, the process selects, using the set of characteristics, a replacement image from a user profile of a user. At block 406, the process replaces, using a generative machine learning model, in a generated advertisement corresponding to the advertisement package, the replaceable portion of the image with the replacement image. At block 408, the process displays, to the user, the generated advertisement. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

CLAIMS:

1. A computer-implemented method comprising:
receiving an advertisement package, the advertisement package comprising an image, a designation of a replaceable portion of the image, and a set of characteristics of a replacement image usable instead of the replaceable portion of the image in a generated advertisement;
selecting, using the set of characteristics, a replacement image from a user profile of a user; and
replacing, using a generative machine learning model, in a generated advertisement corresponding to the advertisement package, the replaceable portion of the image with the replacement image.

2. The computer-implemented method of claim 1, further comprising: displaying, to the user, the generated advertisement.

3. The computer-implemented method of claim 1, wherein the replacement image is selected from a plurality of candidate replacement images identified in the user profile.

4. The computer-implemented method of claim 1, wherein the advertisement package further comprises audio data, a designation of a replaceable portion of the audio data, and a set of characteristics of a replacement audio portion usable instead of the replaceable portion of the audio data in a generated advertisement.

5. The computer-implemented method of claim 4, wherein the set of characteristics of the replacement audio portion comprises text intended to be converted into audio in the generated advertisement.

6. The computer-implemented method of claim 4, further comprising:
selecting, using the set of characteristics, replacement audio data from the user profile of the user; and
replacing, using a second generative machine learning model, in the generated advertisement corresponding to the advertisement package, the replaceable portion of the audio data with the replacement audio data.

7. The computer-implemented method of claim 6, wherein the replacement audio data comprises audio data of the voice of the user.

8. A non-transitory computer-readable medium storing a program, which when executed by a computer, configures the computer to perform the method of claim 1.

9. A system comprising: a processor; and a non-transitory computer-readable medium storing a set of instructions, which when executed by the processor, configure the system to perform the method of claim 1.
